(19) United States
(12) Patent Application Publication
(10) Pub. No.: US 2026/0167509 A1
(43) Pub. Date: Jun. 18, 2026

(54) A METHOD FOR TREATING WASTE SODIUM SULPHATE OBTAINED FROM AN INDUSTRIAL PROCESS, USE OF WASTE SODIUM SULPHATE OBTAINED FROM AN INDUSTRIAL PROCESS AND AN INDUSTRIAL PROCESSING PLANT

(71) Applicant: UMICORE BATTERY MATERIALS FINLAND OY, Kokkola (FI)

(72) Inventors: Ulla LASSI, University of Oulu (FI); Toni KAUPPINEN, University of Oulu (FI); Ari Pekka TYNJÄLÄ, University of Oulu (FI)

(21) Appl. No.: 19/110,580

(22) PCT Filed: Sep. 19, 2023
(86) PCT No.: PCT/EP2023/075778

§ 371 Date: Mar. 11, 2025

(30) Foreign Application Priority Data
Sep. 19, 2022 (FI) 20225809

(51) Int. Cl. C01D 1/20; C01D 1/42

(52) U.S. Cl. CPC C01D 1/20; C01D 1/42; C01P 2006/80

(57) ABSTRACT

Disclosed is a method for treating waste sodium sulphate obtained from an industrial process, the method comprising providing a solution of waste sodium sulphate, providing potassium hydroxide in solid form or as a solution having a concentration of potassium hydroxide of 25% by weight or more and mixing with the solution of waste sodium sulphate to obtain a reaction mixture to convert the waste sodium sulphate to potassium sulphate and sodium hydroxide, and recovering the formed potassium sulphate and the sodium hydroxide. Disclosed also are uses of waste sodium sulphate, and an industrial processing plant.

### TECHNICAL FIELD

The present disclosure relates to a method for treating waste sodium sulphate obtained from an industrial process and to an industrial processing plant. The present disclosure also relates to use of waste sodium sulphate obtained from an industrial process. The present disclosure also relates to a fertilizer product.

### BACKGROUND

Sulphate emissions increase the water salinity and may increase eutrophication. Soluble sulphate salts, such as sodium sulphate (Na₂SO₄) increase the water salinity. The more saline waste water has a higher density than lake water. Due to the density differences, water forms easily two layers: saline water in the bottom and less saline water above. This phenomenon is referred as stratification, which decreases the natural water mixing with the bottom and the surface layer.

Several industrial activities, such as metal refining industry and pulping industry, produce metal sulphates that are increasingly controlled by strict limitations for wastewater concentrations of sulphate. For example, Kraft pulping wastewaters contain sodium sulphates because of the use of NaOH and Na₂S as cooking chemicals. Sulphate concentrations in effluents are typically at the level of 54,000 kg/day. In old pulp mills, sulphate emissions in effluent can be up to 1500 mg/l. Sulphates have not been considered as an effluent parameter of a pulp mill. Therefore, sulphates are seldom removed in the biological waste water treatment. WHO guideline for maximum sulphate content in drinking water is 250 mg/l.

One emerging and quickly increasing industrial area is the production of lithium-ion battery precursors, which are typically prepared by coprecipitation from sulphate-based metal solutions. For example, in Finland, the limits of wastewater sulphate concentrations and the required treatment methods are determined by the environmental permit of the company. The common limit for sulphate concentrations in sewer water is 400 mg/l. Sulphate limitations are placed to reduce the environmental strain caused by the increase in saline concentrations of natural waters, especially in fresh waters.

In prior art sodium sulphate has been converted to potassium sulphate or Glauber salt, or it has been landfilled, which are not practical solutions to solve the issues with emerging waste sodium sulphate.

There is a need to avoid production of sulphate-based waste and salination while increasing industrial production. This requires more efficient methods for wastewater and process water treatment, both for sulphate removal and for the re-use of sulphate-containing wastewaters and process waters.

### SUMMARY

A process was found out for the utilization of waste sodium sulphate from industrial sources, and to convert it back to usable chemicals. The present process overcomes drawbacks of prior art, and provides a zero-waste, low-temperature process, enabling cost-efficient implementing and processing. The process enables the utilization of both products NaOH and K₂SO₄ obtained from sodium sulphate.

The present disclosure provides a method for treating waste sodium sulphate obtained from an industrial process, the method comprising
providing a solution of waste sodium sulphate,
providing potassium hydroxide in solid form or as a solution having a concentration of potassium hydroxide of 25% by weight or more and mixing with the solution of waste sodium sulphate to obtain a reaction mixture to convert the waste sodium sulphate to potassium sulphate and sodium hydroxide, and
recovering the formed potassium sulphate and the sodium hydroxide.

The present disclosure also provides use of waste sodium sulphate obtained from an industrial process for preparing sodium hydroxide with the method.

The present disclosure also provides use of waste sodium sulphate obtained from an industrial process for preparing potassium sulphate with the method for preparing a fertilizer product.

The present disclosure provides an industrial processing plant comprising
an industrial process utilizing sodium hydroxide,
a source of a solution of waste sodium sulphate,
a device arranged to carry out the method, the device comprising
   a reactor,
   mixing means,
   heating means,
   wherein the mixing means and heating means are electrically controllable,
the source of waste sodium sulphate being arranged to be conveyed and/or transported to the reactor,
the obtained sodium hydroxide from the reactor being arranged to be conveyed and/or transported to the industrial process utilizing sodium hydroxide, and
the obtained potassium sulphate being arranged to be recovered from the reactor.

The main embodiments are characterized in the independent claims. Various embodiments are disclosed in the dependent claims. The embodiments and examples disclosed herein are mutually freely combinable unless otherwise explicitly stated.

The present method utilizes inexpensive chemicals and is simple to implement at any industrial location, so any applicable industrial process providing the waste sodium sulphate can be supplemented with the present process with low investments. For example the present reactor or system can be implemented at vicinity of the source of waste sodium sulphate with low costs and can be operated without disturbing the existing facilities and processes.

All the products obtained from the present process can be utilized, so the process improves the current solutions with fully zero-waste approach, and enables the use of obtained NaOH, for example as cooking chemical or precipitant, and the obtained K₂SO₄, for example for fertilizers.

### BRIEF DESCRIPTION OF THE DRAWINGS

FIG. 1 shows one example of the present process

FIG. 2 shows one example of the method of treating waste sodium sulphate

FIG. 3 shows a determined XRD spectra of a solid product obtained from the present process

### DETAILED DESCRIPTION

In this specification, percentage values, unless specifically indicated otherwise, are based on weight (w/w, by weight, or wt %). If any numerical ranges are provided, the ranges include also the upper and lower values. The open term “comprise” also includes a closed term “consisting of” as one option.

As discussed, large amounts of metal sulphates are formed yearly in industrial activities. Sulphate recovery methods, which reduce the sulphate concentration of process waters or wastewaters in commercially viable and efficient ways, have been widely studied. Until now, there has not been a cost-efficient technical method for the treatment of alkaline sulphate waste streams. Acidic sulphate waste streams are typically precipitated with calcium, and the formed gypsum sludge is recovered. Also in this case techno-economic solutions are missing.

Alkaline waste sodium sulphate solution is formed as a by-product in chemical and pulping industry. One example is precipitation of battery precursors from metal sulphate solutions using NaOH as precipitator. As an example, the concentrations of the main elements in waste sodium sulphate are described in Table 1. In addition to the elements mentioned in Table 1, the solution contained ammonium ions with the concentration of 4 g/l as a residue from the chemical coprecipitation.

TABLE 1
The physicochemical characteristics of a waste sodium
sulphate solution (pH 12.5). The values are presented
as mg/l, and only values above 1.0 mg/l were reported.

| SO₄²⁻ | Na | S | Ni | K | TOC | Co |
|---|---|---|---|---|---|---|
| 81000 | 39000 | 28000 | 160 | 160 | 13 | 1.2 |

The present disclosure relates to a process for the utilization, i.e. valorization, of waste sodium sulphate by reaction with potassium hydroxide and water to produce potassium sulphate and sodium hydroxide. Potassium sulphate is a chemical used for fertilizers and it is currently produced via high-temperature processing. NaOH can be recycled back to be used for example as a precipitator in chemical industry or as a cooking chemical in pulping industry.

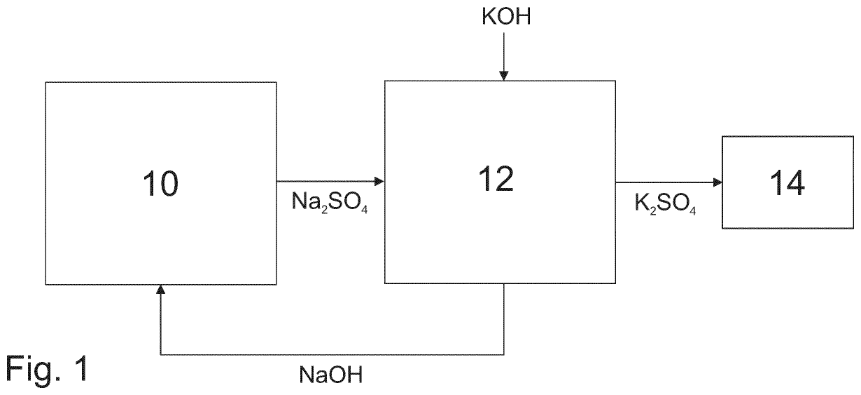

The present disclosure provides a method for treating waste sodium sulphate obtained from an industrial process. An example of the method is disclosed in FIG. 1. The industrial process 10 may be any applicable industrial process, which provides sodium sulphate (Na₂SO₄) in a suitable form, which may be an effluent of an industrial process. Preferably the waste sodium sulphate is alkaline waste sodium sulphate, wherein the pH of the waste solution is at an alkaline range, such as pH of 8 or more, 9 or more, 10 or more, 11 or more, or 12 or more. The sodium sulphate shall be concentrated enough, so for example waste waters containing minor amounts of sodium sulphate are excluded, such as sodium sulphate below 50 g/l, below 30 g/l or below 10 g/l.

The method comprises providing the sodium sulphate as a solution, providing an amount of potassium hydroxide and mixing the potassium hydroxide with the sodium sulphate solution to obtain a reaction mixture. The reaction(s) take(s) place in the reaction mixture 12, and a mixture of end products is obtained. The formed potassium sulphate and the sodium hydroxide are recovered from the mixture of end products. The method may comprise washing of obtained solid material comprising the potassium sulphate, which will decrease the sodium content.

Potassium hydroxide may be provided, such as added, in excess molar amounts to the sodium sulphate. However it may be possible to obtain adequate final concentrations of potassium sulphate and sodium hydroxide for certain applications (other than battery applications) also by using stoichiometric or substoichiometric ratios of potassium hydroxide to sodium sulphate.

The method may comprise converting the waste sodium sulphate to potassium sulphate and sodium hydroxide with the one-step reaction

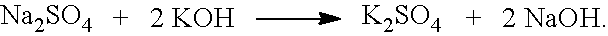

This equation may be also considered as a general equation describing the overall process of the present method, which can be carried out as the one-step reaction or as a two-step reaction.

The method may be carried out also with the two-step reaction having a first step (1) and a subsequent step (2):

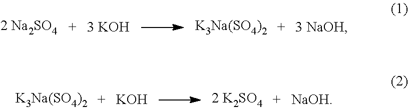

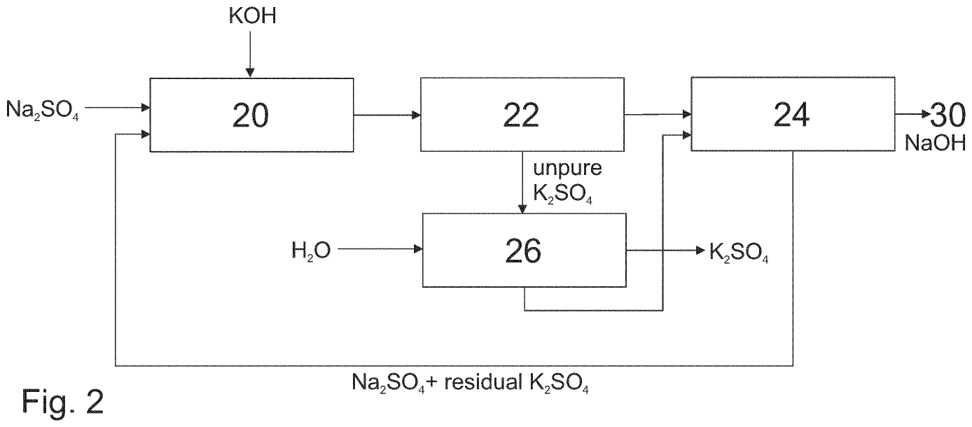

The method may comprise controlling the stoichiometry of reactant in step (1) and/or in step (2) to control the reaction. More particularly the reaction of step (1) may be carried out to a degree wherein less than all reactants are reacted, i.e. to carry out partial reaction. This can be done by maintaining the amount of KOH at a substoichiometric ratio to the sodium sulphate. In step (1) a precipitate mixture is obtained, which is presented as K₃Na(SO₄)₂ in the reaction. More particularly, the precipitate mixture comprises mostly K₃Na(SO₄)₂, but it may also comprise K₂SO₄. It may be also referred to as “unpure potassium sulphate” or “unpure K₂SO₄”, such as in FIG. 2. The precipitate mixture is provided to step (2).

In step (2) the potassium hydroxide may be provided in an excess molar amounts to the sodium sulphate (superstoiciometric ratio). This was found to substantially increase an amount of solid K₂SO₄ obtained from the reaction and respectively decrease an amount of SO₄ residuals in obtained NaOH (i.e. obtained liquid phase), so the NaOH can be used in a variety of applications or industrial processes as such, i.e. without further purification, including purity-sensitive applications and fields of technology, such as battery industry and the like.

In one embodiment the excess molar amount comprises a molar ratio of the potassium hydroxide to the sodium sulphate, such as KOH to Na₂SO₄ and/or K₃Na(SO₄)₂, of 4:1 or more, preferably 5.1 or more. With a molar ratio 5:1 or more, such as 6:1 or more, it was possible to efficiently precipitate almost all sulphate from the sodium sulphate solution. Also the amount of sodium in the final solid precipitate was low, thus making it suitable to be used as a fertilizer.

The potassium sulphate crystallizes in the method and can be separated from the sodium hydroxide, which remains solubilized in solution. The obtained solid potassium sulphate is recovered and it may be provided for example as a fertilizer product or for preparation of a fertilizer product 14, which may be carried out in the same process or in a separate process. Other products comprising or based on potassium sulphate may be prepared as well. The obtained solid potassium sulphate may be transported to another location for further processing, such as for preparing the further product, for example to a fertilizer manufacturer to prepare a fertilizer product

The obtained sodium hydroxide is recovered, and it can be reused as industrial chemical, for example in the same industrial process 10 or a process relating to the same industrial process 10. The industrial process is an industrial process utilizing sodium hydroxide, for example using sodium hydroxide as a process chemical and/or for other purposes in the process or in a related process. The industrial process may be carried out at the same facilities or plant, such as a factory, a mill or any other applicable processing site. However it is possible to provide the sodium hydroxide to another use and/or industrial process, preferably wherein such a use and/or process is located near the site of carrying out the method. Transporting or conveying the obtained sodium hydroxide can be arranged in most industrial plants or other facilities, for example by providing piping or other conveying means, or by arranging transport in containers, for example by using a dedicated conveyer or other transport means, such as vehicle(s), and/or transporting chain.

The solid potassium sulphate and the sodium hydroxide solution can be separated and recovered by using any suitable methods and devices for separating and recovering solids and liquids. The separated and recovered fractions may be analyzed for purity with any suitable means. For example the purity of the potassium sulphate may be analyzed from a sample by using X-ray Powder Diffraction (XRD) and related instrumentation, such as an X-ray powder diffractometer or versatile XRD systems for R&D, to obtain XRD spectra or pattern, which can be used for evaluating the purity of the potassium sulphate and/or the conversion degree in the method, success of the method and the like. The obtained potassium sulphate and sodium hydroxide may be recognized by analysing the fractions. The proceeding of the reaction, such as the conversion degree during the reaction, may be also monitored and/or estimated by using other means, such as monitoring absorbance and/or turbidity of the reaction mixture, detecting formed precipitate and the like.

In one embodiment the method comprises using the recovered sodium hydroxide in the industrial process and/or in a process relating to the industrial process.

Therefore closed or substantially closed process can be provided, especially in respect of sodium sulphate, which process utilizes all or substantially all of the materials provided to the method, especially the sodium hydroxide, and materials obtained from the method. This enables providing industrial processes, which provide less or no waste. As sodium sulphate has been considered as a problematic waste in respect of further usage, and the material has been mainly discarded, the present method enables utilizing the waste and obtaining valuable raw material for the processes. As all the waste sodium sulphate can be utilized, there is no need to find disposal site for the waste, or to apply for any authorization to dispose waste. This enables implementing industrial processes and plants with less environmental issues, less authorizations, less waste water purification units or plants, and to a variety of locations.

In one embodiment the method is a waste-free method comprising utilizing all or substantially all the reaction products and/or reagents, including the waste sodium sulphate. Waste-free refers to a process of treating sodium sulphate, wherein no or substantially no waste is generated. For example a small amount of waste may be obtained comprising or consisting of the impurities present in the waste sodium sulphate, which may have been separated in the process. However the residual impurities are not problematic in all cases, so it may not be necessary to remove the impurities from the final products.

The sodium sulphate may be provided in a reactor or the like container as a solution, such as an aqueous solution. The sodium sulphate solution shall have a high enough concentration, wherein the concentration of the sodium sulphate is 50 g/l or more, such as 80 g/l or more, 100 g/l or more, preferably 120 g/l or more. In one embodiment the sodium sulphate is provided as an aqueous solution having a concentration of 100 g/l or more. The solution may have a concentration of sodium sulphate in the range of 100-450 g/l or 120-450 g/l, such as 120-400 g/l, or 140-300 g/l. It can be directly obtained from the corresponding industrial process generating the sodium sulphate, so the waste sodium sulphate may have not been treated, such as purified, before providing to the present method. However the waste sodium sulphate solution may have been concentrated and/or it is concentrated in the present method. The method may comprise determining and/or obtaining the concentration of the sodium sulphate in the waste sodium sulphate solution. This can be used to determine the required amount of potassium hydroxide, the suitability of the waste solution for the present method, the need for concentrating the waste solution, and/or the need to adjust any other process parameters, and a corresponding decision whether or not to carry out said action, and/or in which extent, can be made based on the determined and/or obtained concentration. The method may comprise providing, such as conveying and/or transporting, waste sodium sulphate from the industrial process, or a process step generating sodium sulphate waste, for example to the container. The waste sodium sulphate may contain small amounts of impurities, but it was found out in the tests that the impurities did not interfere the process and they could be even separated from the sodium sulphate, if necessary.

The sodium sulphate concentration may be adjusted to obtain optimal precipitation of potassium sulphate. A suitable sodium sulphate concentration may be obtained after the concentrating, or the original waste solution may already have such a concentration, such as 2 mol/l or less, or 1.8 mol/l or less, for example 0.3-2.0 mol/l, 0.5-2.0 mol/l (71-284 g/l) or 1-1.8 mol/l (142-256 g/l). With concentrations above 2.5 mol/l the sodium sulphate tends to precipitate, which interferes the present method. It was found out that a concentration in the range of 1.0-2.0 mol/l (142-284 g/l) was optimal in most cases.

The potassium hydroxide may be provided as solid form or as a solution, such as an aqueous solution. The solution may be concentrated solution, such as having a concentration of KOH of 25% by weight or more, such as 30% by weight or more, for example in the range of 30-50% by weight, for example about 30% by weight. Preferably potassium hydroxide is provided in solid form, such as in the form of granules or powder. Solid potassium hydroxide generates heat when solubilized in the aqueous solution, which facilitates the process. Also providing KOH in solid or concentrated form enables implementing the method in a simple, safe and compact form. This has advantages in water and solutions management, and implementation of devices and systems, which can be more compact as no large volumes of KOH are needed.

The potassium hydroxide is mixed with the sodium sulphate. This can be carried out in the reactor, which may be equipped with one or more mixing means, such as one or more mixers, which may comprise one or more mixing blades, agitators, effect of flow and/or the like, and also the effect of flow of liquids may be utilized for obtaining mixing. A reaction mixture is obtained. The reaction mixture, and/or the content of the reactor, is heated, preferably by using one or more heating means, such as one or more heaters, arranged to heat the content of the reactor. The mixing and/or heating may be carried out to obtain a homogenous solution. The reaction mixture may be heated to, or have, a temperature below 100° C., such as 95° C. or less, or 90° C. or less. The temperature is 60° C. or more, such as 70° C. or more, or 80° C. or more. The temperature may be in the range of 60-90° C., such as 60-80° C., 70-90° C. or 80-90° C. Alternatively, or in addition, the solution of sodium sulphate may be provided at elevated temperature and/or may be heated.

The solubilities of sodium and potassium salts are substantially different at temperatures of 60° C. or above, as presented in Table 2.

TABLE 2
Solubilities of key Na and K salts as a function of temperature

| | 0° C. | 20° C. | 40° C. | 60° C. | 80° C. | |
|---|---|---|---|---|---|---|
| NaOH | | 1090 | | 1740 | | g/1000 g |
| | | | | | | H₂O |
| KOH | 957 | | | 1540 | 1700 | g/1000 g |
| | | | | | | H₂O |
| Na₂SO₄ | 49 | 195 | 488 | 453 | 437 | g/1000 g |
| | | | | | | H₂O |
| K₂SO₄ | 74 | 111 | 148 | 182 | 214 | g/1000 g |
| | | | | | | H₂O |

The heating and/or mixing may be carried out for a time period required to allow reacting all or substantially all of the reagents, such as to allow full or substantially full conversion of sodium sulphate to potassium sulphate, for example 90% or more, or 95% or more.

The reaction mixture may be concentrated to remove water. The concentrating may be carried out by evaporating, which takes place at the elevated temperature. In one embodiment the method comprises concentrating the reaction mixture, preferably by evaporating. This may be carried out before and/or after adding the potassium hydroxide.

The solution is cooled or allowed to cool, such as to 50° C. or less, for example to 40° C. or less, preferably to room temperature, such as to 25° C. or less, for example 20-22° C., to obtain crystallized potassium sulphate and a solution of sodium hydroxide. During the cooling, potassium sulphate is crystallized with high purity (>90%) and formed NaOH remains in the solution. The crystallized potassium sulphate forms a suspension, and is allowed to precipitate to obtain solid potassium sulphate precipitate, which can be separated from the remaining NaOH solution.

Preferably the solution is cooled or allowed to cool to a temperature of not less than 2° C., such as not less than 5° C., for example not less than 10° C. Advantageously the cooling is above 1.8° C., which may prevent solidifying sodium sulphate. The temperature may be for example in the range of 2-50° C., such as 2-40° C., or 2-25° C., preferably 5-50° C., such as 5-40° C., or 5-25° C., for example 10-50° C., such as 10-40° C., or 10-25° C., for example to about 30° C.

In one embodiment the method comprises
heating the reaction mixture to 60-90° C., preferably to obtain a homogenous solution,
cooling the solution to 50° C. or less to obtain crystallized potassium sulphate and a solution of sodium hydroxide.

The method may be carried out in a device comprising the means disclosed herein, which means may be controllable, such as electronically controllable. The device may be automated or semi-automated device, and it may be a part of a complex or a system. The device or the system may be a device or a system of pulping and/or papermaking process and/or industry, or battery industry.

In one example the device comprises
a reactor,
mixing means,
temperature controlling means, such as heating and/or cooling means, for example heating and optionally cooling means,
wherein the mixing means and the temperature controlling means are electrically controllable and preferably operatively connected to controlling means, such as one or more control units, arranged to carry out the method steps disclosed herein, such as at least controlling the temperature in the reactor and/or controlling the mixing. The controlling means may be operatively connected to one or more means, devices, actuators, and the like disclosed herein, so that the controlling means can controllably operate the means, and/or connected to one or more sensors and other devices arranged to monitor the process, i.e. to obtain information from the process, such as from the reactor/reaction mixture. The device may comprise cooling means, such as one or more cooler, for example implemented with liquid flow in a rector envelope. The cooling means may be used for cooling the reactor mixture or the homogenous solution to initiate the precipitation. The cooling means may be operatively connected to the control unit.

The device may also comprise one or more of the following
inlet for the waste sodium sulphate solution,
inlet for potassium hydroxide,
outlet for obtained solid potassium sulphate,
outlet for obtained sodium hydroxide solution,
one or more sensors arranged to monitor one or more properties of the reaction mixture and/or the reactor, such as temperature, pH, turbidity, absorbance, flow rate, liquid level, conductivity or the like,
one or more pumps for conveying the solutions, which pumps may be operatively connected to the control unit,
one or more further containers disclosed herein and required connections, such as pipes,
one or more valves for controlling flow of the solutions and/or solids, and/or
one or more actuators connected to one or more moving members for mixing, moving and/or otherwise controlling the process, which actuators may be operatively connected to the control unit. The valves may be electrically controllable valves comprising an actuator operatively connected to the control unit. The device may comprise a container for potassium hydroxide, which is connected via a controllable valve or other controlling means, for example operatively connected to the control unit, so that dosing of the potassium hydroxide can be controlled. The container may comprise a funnel for allowing flow of solid potassium hydroxide. The device may comprise means for outletting the obtained solid potassium sulphate, such as at the bottom of the reactor, for example an actuator connected to one or more movable members for moving the solid potassium sulphate, which means may be operatively connected to the control unit.

The device may comprise an inlet for solid potassium hydroxide or an inlet for concentrated solution of potassium hydroxide, which may have a concentration disclosed herein.

The present device utilizes the mixing means, such as a mixer, to confirm immediate solubilization of the solid KOH or the concentrated solution of potassium hydroxide, which facilitates avoiding local concentration gradients. Even though heating or cooling is not necessarily required at first, for example due to generation of heat by the solubilization of KOH or due to need for lowering the temperature, using the temperature controlling means enable a simple control of the reaction by maintaining the temperature of the reaction mixture optimal during the process. The temperature controlling means may comprise one or more heating and/or cooling elements arranged to control the temperature of the rector and/or the reaction mixture in the reactor.

The inlet for solid potassium hydroxide or the inlet for concentrated solution of potassium hydroxide may be connected to a container for the solid potassium hydroxide or the concentrated solution of potassium hydroxide. The use of the concentrated potassium hydroxide enable providing a container with a relatively small volume, which enables implementing the system and the device in a compact form.

The industrial processing plant may be an industrial processing plant of pulping and/or papermaking process and/or industry, or an industrial processing plant of battery industry.

The control unit may be electronic control unit, which may be programmable, comprising one or more processors, memory, and software configured, when executed with a processor in the control unit, to carry out one or more operations to implement the method, for example to adjust the temperature of the reaction mixture by controlling the temperature controlling means, such as the heating and/or the cooling means, to control the mixing means to obtain a desired mixing of the reaction mixture, monitor the temperature and/or other properties of the reaction mixture with one or more sensors in the reactor, and the like operations. The control unit may be arranged, such as programmed, to monitor one or more properties from the device, the system, and/or the reactor, for example as a function of time, and as feedback to the monitored properties carry out one or more control actions in the device or the system to adjust the function of the device to carry out the present method. Properties such as temperature, pH, turbidity, absorbance, conductivity, flow rate, liquid level, control of addition of substances, mixing rate, and the like may be monitored with one or more sensors arranged to monitor said properties. For example temperature may be controlled to be at a predetermined range and/or to increase and/or decrease in a controlled manner to carry out the method.

The present disclosure provides an industrial processing plant, or a system or a device arrangement in the industrial process plant, or the like processing site, comprising
an industrial process utilizing sodium hydroxide,
a source of waste sodium sulphate, which may be the industrial process utilizing sodium hydroxide, a related industrial process and/or a separate industrial process,
a device arranged to carry out the method, the device comprising
   a reactor,
   mixing means,
   temperature controlling means, such as heating and/or cooling means,
   wherein the mixing means and heating means are electrically controllable and preferably operatively connected to a control unit arranged to carry out the method steps, such as at least controlling the temperature in the reactor and/or controlling the mixing,
the source of waste sodium sulphate being arranged to be conveyed and/or transported to the reactor,
the obtained sodium hydroxide from the reactor being arranged to be conveyed and/or transported to the industrial process utilizing sodium hydroxide, and
the obtained potassium sulphate being arranged to be recovered from the reactor.

The present method and overall process may be implemented in different ways by different operators, and the whole production chain, such as the actions carried out by different operators, can be facilitated with the method. The method may be carried out by one operator, or it may be carried out by two or more operators. For example a first operator may generate the waste sodium sulphate. Such an operator may run the industrial process, which may be carried out in a factory, a plant or other applicable production or processing site, and which may be an industrial process utilizing sodium hydroxide 10. The waste sodium sulphate may be collected into containers, or it may be provided directly from the process, for example via a pipe or the like conveying means. The first operator may also provide the waste sodium sulphate to the site, wherein the present reaction is carried out, which may be called site of use. It is also possible that another operator provides the waste sodium sulphate, for example when the waste sodium sulphate is collected into containers and transported to the site of use. The present reaction(s) 12 may be carried out by the first or the second operator, but it/they may be also carried out by another, third operator. This operator operates the reactor, doses potassium hydroxide, and recovers the reaction products. This operator may also provide the reaction products to further use, and the operator may also carry out one or both of the further uses, namely using the sodium hydroxide as industrial chemical and/or providing the potassium sulphate to preparation of a fertilizer 14, or preparing the fertilizer. However it is also possible that one or two further operators carry out these steps, and/or that the first operator carries out the step of using the sodium hydroxide as industrial chemical in an industrial process 10. An operator which may utilize the obtained potassium sulphate may be a fertilizer manufacturer.

One example of the present process of treating the waste sodium sulphate is presented in FIG. 2. This process utilizes two precipitations steps and can provide end products with high purity. The process of FIG. 2 may be included in step 12 of FIG. 1.

Sodium sulphate (Na₂SO₄) waste solution is fed to a reactor in step 20, concentrated (30%) potassium hydroxide (KOH) in solid form as pellets is added, and the obtained solution is mixed and heated to 80° C. to obtain a homogenous solution. The solution is concentrated by evaporating at the increased temperature. The mixture is cooled down to 50° C. in step 22, wherein potassium sulphate (K₂SO₄) is crystallized and contains some residual sodium sulphate. This obtained impure potassium sulphate is solubilized to a minimum amount of water at 80° C. for purification crystallization step 26 and crystallized by cooling down to 50° C. Pure potassium sulphate is obtained from step 26, and can be recovered.

The remaining solutions from steps 22 and 26 are crystallized at a second crystallization step 24 by cooling down to 0-20° C. Regenerated NaOH, Na₂SO₄ and residual K₂SO₄ are obtained at step 30. The NaOH can be recovered and reused, such as conveyed to an industrial process. The residual solution comprising Na₂SO₄ and residual K₂SO₄ from step 30 is conveyed back to step 20. Alternatively the residual solution comprising Na₂SO₄ and residual K₂SO₄ from step 26 may be conveyed directly back to step 20 to avoid diluting the NaOH solution of the second crystallization step 24.

The present method may be applied to different industrial processes 10, which provide waste sodium sulphate.

In one embodiment the industrial process 10 is a pulping process. A pulping process refers to a process, or a system setup, including or involving pulping and/or cooking in the pulping process, including the production of cooking chemicals. One such a source of sodium sulphate is the removal of sodium sulphate from the recovery cycle due to excess sulphur. The traditional way to control sodium and sulfur balance is to remove a part of recovery boiler fly ash, which includes mainly sodium sulphate and sodium carbonate. Sodium sulphate has been conventionally either dissolved in waste water or utilized as a make-up chemical. If the sodium sulphate is dissolved in waste water, it increases the sulphate emissions. On the other hand, if it is used as a make-up chemical, it may increase the excess sulfur in the Na/S-balance. The excess sulfur may lead to increased fly ash purging, which also increases the sulphate emissions.

With the present method it is possible to lower the sodium sulphate content of waste waters or other emissions of pulping processes, or pulping mills, and to allow better control of the process as there is no need to use sodium sulphate as a make-up chemical.

In one embodiment the method comprises using the recovered sodium hydroxide as a cooking chemical in the pulping process, such as caustic soda, for example in white liquor and/or in bleaching.

Sodium hydroxide may be used in papermaking process, such as paper recycling to separate ink form recycled paper. In one embodiment the industrial process 10 is a papermaking process In one embodiment the industrial process 10 is a process of battery industry.

In such case the method may comprise using the recovered sodium hydroxide as a precipitator, such as for precipitation of battery precursors from metal sulphate solutions.

In certain processes of battery industry transition metal (M) sulphates, such as nickel sulphates, are treated with sodium hydroxide to precipitate transition metal hydroxides with the reaction:

MSO₄+2NaOH→M(OH)₂+Na₂SO₄

Sodium sulphate is generated in the process as a waste solution.

In one example nickel hydroxide is prepared as a precursor for manufacturing LiNiO₂ (LNO) to be used as cathode material in Li-ion batteries. Spherical Ni(OH)₂ precursors are synthetized using alkali metal hydroxide coprecipitation in an inert gas atmosphere. Also this reaction uses NaOH for precipitating nickel hydroxide in the following reactions:

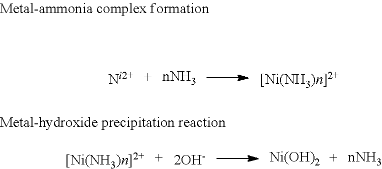

In one embodiment the method comprises using the recovered sodium hydroxide as a precipitating chemical and/or pH adjusting agent for treating waste water.

The sodium hydroxide may be also used as industrial cleaning agent, wherein it may be used to clean process equipment, storage tanks and the like, as sodium hydroxide can dissolve grease, oils, fats and protein-based depots. It may be also used for making soaps and other detergents.

The obtained sodium hydroxide, or part thereof, may be used for other purposes than the discussed industrial process 10, such as in, or for preparing, cement (for example in a plasticizer), cleaning agent, water treatment agent, food treatment agent, esterification and/or transesterification reagent, solvent for amphoteric metals and compounds, or a reagent for making artificial textile fibers. The method may comprise separating and/or recovering part of the obtained sodium hydroxide, and using it as, or for preparing, any of the agents disclosed herein, and/or for any of the uses disclosed herein.

In one embodiment the method comprises providing the crystallized potassium sulphate for preparation of a fertilizer product, preferably by combining with one or more substances acting as a fertilizer, as a filler, and/or as a stabilizer. In one example the fertilizer is a NPK fertilizer. NPK fertilizers comprise nitrogen, phosphorus and potassium, and they can be manufactured by steam granulation, by chemical granulation, by compaction, or by bulk blending. The present obtained potassium sulphate may be provided as an ingredient for preparing such fertilizers or other types of fertilizers. The preparation of the fertilizer product may comprise providing the potassium sulphate, providing one or more substances acting as a fertilizer, as a filler, and/or as a stabilizer, mixing to obtain a mixture, and forming the mixture into a fertilizer product. The fertilizer products may be formed into granules, powder, or to any other applicable form. In one embodiment the method comprises preparing a fertilizer product comprising the crystallized potassium sulphate.

Disclosed is a fertilizer product comprising the potassium sulphate obtained with the method disclosed herein. The fertilizer product may be in a form of dry powder or dry granules, which may have a moisture content of 20% by weight or less, such as 15% by weight or less or 10% by weight or less.

The present disclosure provides use of waste sodium sulphate obtained from an industrial process in the process comprising converting the waste sodium sulphate to potassium sulphate and sodium hydroxide with the reaction

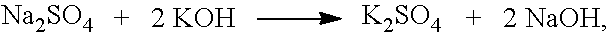

wherein the potassium sulphate is recovered and provided as, or for preparing, a fertilizer product, and/or wherein the sodium hydroxide is recovered and preferably used in the industrial process and/or in a process relating to the industrial process.

The process comprising converting the waste sodium sulphate to potassium sulphate and sodium hydroxide may comprise any of the methods and/or using any of the devices disclosed herein.

The present disclosure provides use of waste sodium sulphate obtained from an industrial process for preparing sodium hydroxide with the method disclosed herein. The sodium hydroxide is preferably used in the industrial process and/or in a process relating to the industrial process, as discussed.

The present disclosure provides use of waste sodium sulphate obtained from an industrial process for preparing potassium sulphate with the method disclosed herein. Preferably the potassium sulphate is for preparing a fertilizer product.

### EXAMPLES

### Example 1

The present process is carried out as a one-step process, with sodium sulphate and potassium hydroxide as follows:

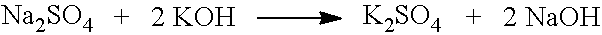

Alkaline waste sodium sulphate solution (250 ml) obtained from a process for preparing metal hydroxides for batteries is mixed by stirring with excess of KOH solution (21 g of KOH pellets in water) and heated up to 80-90° C. to form a fully homogenous solution. Potassium sulphate is precipitated by cooling the reaction system down to 50° C. (vaporization of around 125 ml), leading to the formation of almost pure potassium sulphate (white powder) and a solution of concentrated NaOH (supernatant solution) is formed. These are separated and recovered.

### Example 2

The present process is carried out as two-step process, with sodium sulphate and potassium hydroxide as follows:

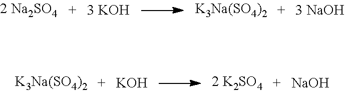

Alkaline waste sodium sulphate solution (250 ml) obtained from a process for preparing metal hydroxides for batteries is mixed by stirring with excess of KOH solution (21 g of KOH pellets is water) and heated up to 80-90° C. to form a fully homogenous solution. Potassium sulphate is precipitated by cooling the reaction system down to 50° C. (vaporization of around 125 ml), leading to the formation of almost pure potassium sulphate (white powder) and a solution of NaOH (supernatant solution) is formed. These are separated and recovered.

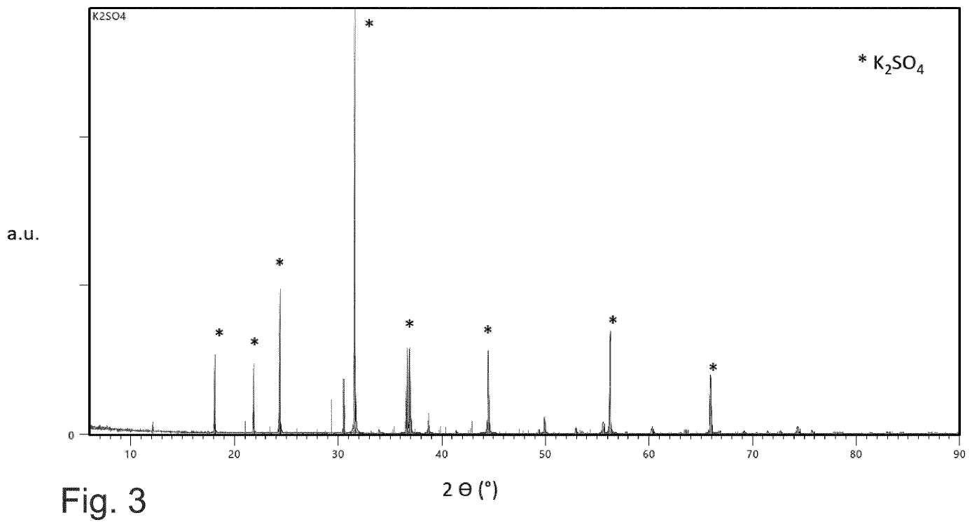

An X-ray Powder Diffraction (XRD) spectra was determined with PANalytical Powder XRD device for the obtained crystalline potassium sulphate and is presented in FIG. 3. It can be seen from the spectra that most of the peaks represent potassium sulphate and there are only trace amounts of impurities, mainly unreacted sodium sulphate and potassium sodium sulphate.

### Example 3: One-Step Reaction

1 M Na₂SO₄ solution was prepared by dissolving solid Na₂SO₄ into deionized water. Then eight separate Examples, 3.1-3.8, were conducted wherein in each example, 200 ml of the prepared Na₂SO₄ solution was added into an Erlenmeyer flask and the initial temperature of the solution was measured. Then the amount of KOH pellets as described in Table 3 below was added to the flask in small batches and continuously stirred by magnetic stirrer to form a fully homogenous solution. After all KOH was added, the temperature of the solution was recorded and the mixing was then ended and the solution was allowed to cool down to 30° C., followed by filtering to separate the obtained solid and liquid fractions.

The analysis of the obtained solid and liquid fractions, including X-ray diffraction (XRD) for the solid and Inductively Coupled Plasma (ICP) of the elemental composition analysis for the solid and liquid, were conducted as described later and the results are given in Table 4.

TABLE 3

| | | Amount of | Temperature | Temperature |
|---|---|---|---|---|
| | Molar ratio of | added KOH | before KOH | after KOH |
| Example | KOH:Na₂(SO₄) | (g) | (° C.) | (° C.) |
| 3.1 | 1:1 | 11.22 | 20.3 | 26.8 |
| 3.2 | 1.5:1 | 16.83 | 20.3 | 30.0 |
| 3.3 | 2:1 | 22.44 | 20.1 | 33.4 |
| 3.4 | 3:1 | 33.66 | 21.1 | 40.9 |
| 3.5 | 4:1 | 44.88 | 20.4 | 45.4 |
| 3.6 | 5:1 | 56.11 | 20.3 | 50.2 |
| 3.7 | 6:1 | 67.33 | 20.4 | 57.6 |
| 3.8 | 8:1 | 89.77 | 20.5 | 65.0 |

TABLE 4

| | | Conversion | XRD analysis | | | | | | | |
|---|---|---|---|---|---|---|---|---|---|---|
| | Obtained | of | | Mass | ICP analysis (filtrate) | | | ICP analysis (solid) | | |
| | solid | SO₄ | Main | fraction ^{γ} of | K | Na | S | K | Na | S |
| Example | (g) | (%) | phase | NaK₃(SO₄)₂ ^{α}:K₂SO₄ ^{β} | (g/l) | (g/l) | (g/l) | (wt. %) | (wt. %) | (wt. %) |
| 3.1 | 0 | — | — | — | 34.32 | 45.28 | 31.69 | — | — | — |
| 3.2 | 2.18 | 12.1 | NaK₃(SO₄)₂ ^{α} | 100:0 | 42.05 | 41.11 | 28.18 | — | — | — |
| 3.3 | 10.66 | 35.6 | NaK₃(SO4)₂ ^{α} | 100:0 | 47.08 | 39.76 | 20.65 | 36.41 | 8.43 | 19.06 |
| 3.4 | 22.1 | 66.4 | NaK₃(SO₄)₂ ^{α} | 95:5 | 55.73 | 33.64 | 10.78 | 36.92 | 8.36 | 18.65 |
| 3.5 | 27.53 | 84.4 | NaK₃(SO₄)₂ ^{α} + | 57:43 | 74.28 | 37.79 | 5.00 | 40.40 | 5.48 | 18.36 |
| | | | K₂SO₄ ^{β} | | | | | | | |
| 3.6 | 31.11 | 91.4 | K₂SO₄ ^{β} | 0:100 | 78.61 | 37.41 | 2.75 | 47.30 | 0.93 | 17.67 |
| 3.7 | 34.63 | 95.2 | K₂SO₄ ^{β} | 0:100 | 113.4 | 40.81 | 1.55 | 46.33 | 1.41 | 16.65 |
| 3.8 | 37.15 | 98.1 | K₂SO₄ ^{β} | 0:100 | 162.4 | 40.12 | 0.60 | 44.25 | 1.30 | 16.03 |

^{α} For NaK₃(SO4)₂ ICDD reference number of 00-020-0928 was used.
^{β} For K₂SO₄ ICDD reference number of 04-005-7905 was used.
^{γ} A mass fraction calculated based on the Rietveld refinement analysis.

In Example 3.1 with molar ratio of 1:1 KOH and Na₂SO₄ not any solid material was obtained.

In Example 3.2 with molar ratio of KOH and Na₂SO₄ of 1.5:1 resulted in a small amount of solid that was not enough to ICP analysis.

In Examples 3.2 and 3.3 the main solid phase obtained was NaK₃(SO₄)₂.

In Examples 3.6, 3.7 and 3.8 with a large excess of KOH it was possible to precipitate almost all sulphate from the sodium sulphate solution. The main solid phase obtained was K₂SO₄.

Using a large excess (4:1) of KOH produced mainly K₂(SO₄) as a solid material with some impurities.

Washing of the obtained solid material (not done in this example) would decrease the sodium content.

### Example 4: Two-Step Reaction

First in Example 4.1 1 M Na₂SO₄ solution was prepared by dissolving solid Na₂SO₄ into deionized water. Then 1 l of the prepared Na₂SO₄ solution was added into an Erlenmeyer flask and mixed with 112.21 g of KOH pellets by magnetic stirrer to form a fully homogenous solution. After all KOH was added, the temperature of the solution of 33.2° C. was recorded and the mixing was then ended and the solution was allowed to cool down to 25° C., followed by filtering to separate the obtained solid and liquid fractions.

The analysis of the obtained solid and liquid fractions, including X-ray diffraction (XRD) for the solid and Inductively Coupled Plasma (ICP) of the elemental composition analysis for the solid and liquid, were conducted as described later and the results are given in Table 6. As reported in Table 6 the main phase of the obtained solid material of Example 4.1 was NaK₃(SO₄)₂.

Further, four separate Examples, 4.2-4.5, were conducted wherein in each example, 4.0 g of the obtained solid material (i.e. precipitate mixture comprising NaK₃(SO₄)₂) and 12 ml of deionized water were added and mixed in an Erlenmeyer flask, followed by adding the amount of KOH pellets as described in Table 5 below to the flask in small batches and continuously stirred by magnetic stirrer to form a fully homogenous solution. After all KOH was added, the temperature of the solution was recorded and the mixing was then ended and the solution was allowed to cool down to 30° C., followed by filtering to separate the obtained solid and liquid fractions.

The analysis of the obtained solid and liquid fractions, including X-ray diffraction (XRD) for the solid and Inductively Coupled Plasma (ICP) of the elemental composition analysis for the solid and liquid, were conducted as described later and the results are given in Table 6.

TABLE 5

| | | | | Amount of |
|---|---|---|---|---|
| | | Amount of | Amount of | added |
| | Molar ratio of | added KOH | added | precipitate |
| Example | KOH:Na₂SO₄ | (g) | water (ml) | mixture |
| 4.1 | 2:1 | 112.20 | 1000 | — |
| 4.2 | 1 | 0.35 | 9 | 3.0 |
| 4.3 | 1.2 | 0.42 | 9 | 3.0 |
| 4.4 | 1.5 | 0.53 | 9 | 3.0 |
| 4.5 | 2 | 0.70 | 9 | 3.0 |

TABLE 6

| | | Conversion | XRD analysis | | | | | | | |
|---|---|---|---|---|---|---|---|---|---|---|
| | Obtained | of | | Mass | ICP analysis (filtrate) | | | ICP analysis (solid) | | |
| | solid | SO₄ | Main | fraction ^{γ} of | K | Na | S | K | Na | S |
| Example | (g) | (%) | phase | NaK₃(SO₄)₂ ^{α}:K₂SO₄ ^{β} | (g/l) | (g/l) | (g/l) | (wt. %) | (wt. %) | (wt. %) |
| 4.1 | 13.64 | 31.9% | NaK₃(SO₄)₂ ^{α} | 100:0 | 47.04 | 36.92 | 21.82 | 34.18 | 7.05 | 18.74 |
| 4.2 | 2.26 | 40.7% | K₂SO₄ ^{β} | 5:95 | 56.13 | 23.36 | 19.80 | 43.96 | 1.08 | 17.50 |
| 4.3 | 2.37 | 49.6% | K₂SO₄ ^{β} | 4:96 | 56.18 | 19.74 | 16.81 | —* | —* | —* |
| 4.4 | 2.55 | 67.3% | K₂SO₄ ^{β} | 2:98 | 53.72 | 20.07 | 10.91 | —* | —* | —* |
| 4.5 | 2.83 | 78.5% | K₂SO₄ ^{β} | 1:99 | 64.52 | 20.20 | 7.16 | —* | —* | —* |

^{α} For NaK₃(SO4)₂ ICDD reference number of 00-020-0928 was used.
^{β} For K₂SO₄ ICDD reference number of 04-005-7905 was used.
^{γ} A mass fraction calculated based on the Rietveld refinement analysis.
*There were problems in the measurement and not a reliable result was obtained.

According to XRD and ICP analysis in Example 4.1 the obtained solid material was NaK₃(SO₄)₂.

In Example 4.2 the obtained solid material is mainly K₂SO₄ with some NaK₃(SO₄)₂.

Washing of the obtained solid material (not done in this example) would decrease the sodium content.

### Example 5: The Effect of Na₂SO₄ Concentration

First in Example 5.1, three different Na₂SO₄ solutions with concentrations of 0.5 M, 1 M and 1.5 M were prepared by dissolving solid Na₂SO₄ into deionized water. Then, three sets of examples were conducted and analyzed in the same way as in Example 5.1 by using each of three Na₂SO₄ solutions with four different molar ratios of KOH:Na₂SO₄ of 2:1, 4:1, 6:1 and 8:1 (Examples 5.2-5.12). Table 7 shows the concentrations of the Na₂SO₄ solutions, molar ratios of KOH:Na₂SO₄ and amount of KOH pellets used in Examples 5.1-5.12 and the analysis results are given in Table 8, respectively.

TABLE 7

| | Na₂SO₄ | | Amount | Temper- | Temper- |
|---|---|---|---|---|---|
| | concen- | Molar ratio | of | ature | ature |
| Exam- | tration | of | added | before KOH | after KOH |
| ple | (mol/l) | KOH:Na₂SO₄ | KOH (g) | (° C.) | (° C.) |
| 5.1 | 0.5 | 2:1 | 11.22 | 21.6 | 28.5 |
| 5.2 | 0.5 | 4:1 | 22.44 | 21.6 | 34.5 |
| 5.3 | 0.5 | 6:1 | 33.66 | 21.0 | 40.8 |
| 5.4 | 0.5 | 8:1 | 44.88 | 21.6 | 46.4 |
| 5.5 | 1.0 | 2:1 | 22.44 | 21.7 | 35.1 |
| 5.6 | 1.0 | 4:1 | 44.88 | 21.6 | 47.3 |
| 5.7 | 1.0 | 6:1 | 67.33 | 21.7 | 57.7 |
| 5.8 | 1.0 | 8:1 | 89.77 | 21.7 | 65.6 |
| 5.9 | 1.5 | 2:1 | 33.66 | 21.7 | 43.1 |
| 5.10 | 1.5 | 4:1 | 67.33 | 23.1 | 60.3 |
| 5.11 | 1.5 | 6:1 | 100.99 | 22.2 | 69.5 |
| 5.12 | 1.5 | 8:1 | 134.65 | 21.9 | 77.5 |

TABLE 8

| | | XRD analysis | | | | |
|---|---|---|---|---|---|---|
| | | | Mass | ICP analysis (filtrate) | | |
| | Obtained | Main | fraction ^{γ} of | K | Na | S |
| Example | solid (g) | phase | NaK₃(SO₄)₂ ^{α}:K₂SO₄ ^{β} | (g/l) | (g/l) | (g/l) |
| 5.1 | — | — | — | 39.90 | 23.10 | 8.02 |
| 5.2 | 0.34 | — | — | 79.17 | 22.98 | 7.84 |
| 5.3 | 9.53 | K₂SO₄ ^{β} | 0:100 | 97.89 | 23.10 | 3.25 |
| 5.4 | 12.36 | K₂SO₄ ^{β} | 0:100 | 131.31 | 23.10 | 2.04 |
| 5.5 | 9.04 | NaK₃(SO₄)₂ ^{α} | 95:5 | 62.92 | 42.94 | 11.66 |
| 5.6 | 23.62 | K₂SO₄ ^{β} | 0:100 | 105.52 | 46.20 | 4.62 |
| 5.7 | 29.98 | K₂SO₄ ^{β} | 0:100 | 170.77 | 46.20 | 1.54 |
| 5.8 | 19.97 | K₂SO₄ ^{β} | 0:100 | 273.50 | 46.20 | —* |
| 5.9 | 38.78 | NaK₃(SO₄)₂ ^{α} | 100:0 | 47.26 | 55.32 | 5.30 |
| 5.10 | 39.61 | K₂SO₄ ^{β} | 0:100 | 148.71 | 69.30 | 4.90 |
| 5.11 | 42.59 | K₂SO₄ ^{β} | 0:100 | 261.60 | 69.30 | 3.46 |
| 5.12 | 44.82 | K₂SO₄ ^{β} | 0:100 | 376.21 | 69.30 | 2.39 |

^{α} For NaK₃(SO₄)₂ ICDD reference number of 00-020-0928 was used.
^{β} For K₂SO₄ ICDD reference number of 04-005-7905 was used.
^{γ} A mass fraction calculated based on the Rietveld refinement analysis.
*There were problems in the measurement and not a reliable result was obtained.

Examples 5.1-5.12 show that when the concentration of Na₂(SO₄) solution increases the amount of the solid fraction obtained in the same molar ratio of KOH:Na₂SO₄ increases.

Examples 5.1-5.12 show that when the amount of KOH increases the sulphate content in the liquid fraction decreases.

Washing of the obtained solid material (not done in this example) would decrease the sodium content.

### X-Ray Diffraction Analysis of Examples 3-5.

The XRD spectra of the samples were measured with an X-ray diffractometer EMPYREAN® by a manufacturer of PANalytical with the conditions as described in Table 9 below.

TABLE 9
XRD measurement conditions

| Anode material | Co | |
|---|---|---|
| K-Alpha 1 wavelength | 1.78901 | Å |
| Generator voltage | 40 | kV |
| Tube current | 45 | mA |
| Scan Range | 10-90° | |
| Scan Step Size | 0.0130° | |
| Scan step time | 178.24 | s |

| | |
|---|---|
| Divergence slit | 0.355° |
| detector opening | 3.3482° |
| primary soller slit | 0.04 |

### Elemental Composition Analysis of Examples 3-5

The contents of K, Na and S in the obtained solid fraction and liquid fraction samples were measured by the Inductively Coupled Plasma—Optical Emission Spectrometry (ICP-OES) method using an Thermo iCAP 6000 Series ICP-OES instrument.

The measurement sample was prepared as follows for solid samples: 0.25 gram of a powder sample of each example was dissolved into deionized (DI) water in a 100 ml volumetric flask. The volumetric flask was filled with deionized (DI) water up to the 100 ml mark, followed by complete homogenization. 1 ml of the solution was taken out by a pipette and transferred into a 100 ml volumetric flask for the second dilution. An appropriate amount of a concentrated nitric acid was added by a pipette to achieve 5% HNO₃ solution when brought to volume with deionized water (DI) and then homogenized. Finally, this solution was used for the ICP-OES measurement. The contents of K, Na and S are expressed as %.

The measurement sample was prepared as follows for liquid samples: 1 ml of liquid sample was taken out by a pipette and transferred into a 100 ml volumetric flask. The volumetric flask was filled with deionized (DI) water up to the 100 ml mark, followed by complete homogenization. An appropriate amount of the solution was taken out by a pipette and transferred into a 100 ml or 250 ml volumetric flask for the second dilution. An appropriate amount of a concentrated nitric acid was added by a pipette to achieve 5% HNO₃ solution when brought to volume with deionized water (DI) and then homogenized. Finally, the solution was used for the ICP-OES measurement. The contents of K, Na and S are expressed as g/l.

1-24. (canceled)

25. A method for treating waste sodium sulphate obtained from an industrial process, the method comprising:
providing a solution of waste sodium sulphate,
providing potassium hydroxide in solid form or as a solution having a concentration of potassium hydroxide of 25% by weight or more, wherein the potassium hydroxide is provided in an excess molar amount to the sodium sulphate, and mixing with the solution of waste sodium sulphate to obtain a reaction mixture as a homogenous solution having a temperature in the range of 60-90° C. to convert the waste sodium sulphate to potassium sulphate and sodium hydroxide,
cooling the solution, or allowing the solution to cool, to 50° C. or less to obtain crystallized potassium sulphate and a solution of sodium hydroxide, and
recovering the formed crystallized potassium sulphate and the solution of sodium hydroxide.

26. The method of claim 25, wherein the waste sodium sulphate is converted to potassium sulphate with the reaction:

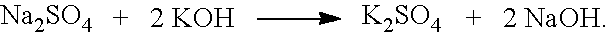

27. The method of claim 25, wherein the waste sodium sulphate is converted to potassium sulphate with the two-step reaction:

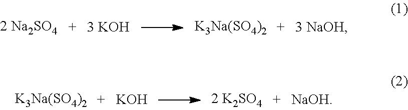

28. The method of claim 27, wherein the potassium hydroxide is provided in an excess molar amount to the sodium sulphate in the step (2).

29. The method of claim 25, wherein the excess molar amount comprises a molar ratio of the potassium hydroxide to the sodium sulphate of 4:1 or more.

30. The method of claim 25, wherein the potassium hydroxide is provided in solid form.

31. The method of claim 25, wherein the potassium hydroxide is provided as a solution having a concentration of potassium hydroxide of 30% by weight or more, such as in the range of 30-50% by weight.

32. The method of claim 25, wherein the solution of waste sodium sulphate is a solution of alkaline waste sodium sulphate.

33. The method of claim 25, comprising:
heating the reaction mixture to 60-90° C.,
cooling the solution to 50° C. or less to obtain crystallized potassium sulphate and a solution of sodium hydroxide.

34. The method of claim 25, wherein the sodium sulphate is provided as an aqueous solution having a concentration of 100 g/l or more.

35. The method of claim 25, further comprising concentrating the reaction mixture.

36. The method of claim 25, comprising using the recovered sodium hydroxide in the industrial process and/or in a process relating to the industrial process.

37. The method of claim 25, wherein the industrial process is a pulping and/or papermaking process.

38. The method of claim 37, comprising using the recovered sodium hydroxide as a cooking chemical in the pulping process.

39. The method of claim 25, wherein the industrial process is a process of battery industry.

40. The method of claim 25, comprising using the recovered sodium hydroxide as a precipitating chemical and/or pH adjusting agent for treating waste water.

41. The method of claim 25, wherein the method is a waste-free method comprising utilizing all the reaction products.

42. The method of claim 25, comprising providing the crystallized potassium sulphate for preparation of a fertilizer product.

43. An industrial processing plant comprising:
an industrial process utilizing sodium hydroxide,
a source of a solution of waste sodium sulphate,
a device arranged to carry out the method of claim 25, the device comprising
a reactor,
mixing means,
temperature controlling means,
wherein the mixing means and temperature controlling means are electrically controllable,
the source of waste sodium sulphate being arranged to be conveyed and/or transported to the reactor,
the obtained sodium hydroxide from the reactor being arranged to be conveyed and/or transported to the industrial process utilizing sodium hydroxide, and
the obtained potassium sulphate being arranged to be recovered from the reactor.

44. The industrial processing plant of claim 43, wherein the device comprises an inlet for solid potassium hydroxide or an inlet for concentrated solution of potassium hydroxide.

45. The industrial processing plant of claim 43, wherein the industrial processing plant is an industrial processing plant of pulping and/or papermaking process.

46. The industrial processing plant of claim 43, wherein the industrial processing plant is an industrial processing plant of battery industry.
